(19) United States
(12) Patent Application Publication
(10) Pub. No.: US 2016/0255429 A1
(43) Pub. Date: Sep. 1, 2016

(54) AUDIO SIGNAL AMPLIFICATION APPARATUS AND METHOD OF USE

(71) Applicant: Omar F. Dickson, College Point, NY (US)

(72) Inventor: Omar F. Dickson, College Point, NY (US)

(21) Appl. No.: 15/019,519

(22) Filed: Feb. 9, 2016

Related U.S. Application Data
(60) Provisional application No. 62/126,593, filed on Feb. 28, 2015.

(51) Int. Cl. H04R 1/02; G01F 23/22; H04R 3/00

(52) U.S. Cl. CPC H04R 1/02; H04R 3/00; G01F 23/22

(57) ABSTRACT

An audio signal amplification apparatus includes a clamp body assembly for clamping onto a vent pipe of an oil tank and an amplifier control assembly having a PC board containing amplifier circuitry configured for amplifying a vent alarm sound coming from the vent pipe and wirelessly transmitting the amplified vent alarm sound to a receiver carried by a person filling the oil tank. The clamp body assembly includes a central shell subassembly supporting the PC board and a pair of curved arm members extending from opposite sides of the central shell subassembly for surrounding and clamping on a portion of the vent pipe so as to facilitate attaching the amplifier control assembly to the vent pipe. The apparatus further includes a clamp device adjustably attaching the apparatus onto a vent pipe of one of different cross-sectional sizes.

### CROSS REFERENCE(S) TO RELATED APPLICATION(S)

This U.S. non-provisional patent application claims the benefit of U.S. provisional patent application No. 62/126,593, filed on Feb. 28, 2015, which is hereby incorporated-by-reference herein its entirety.

### FIELD OF THE INVENTION

The present invention generally relates to audio amplification devices. More particularly, the invention pertains to an audio signal amplification apparatus and a method of use for amplifying an audio signal emitted from a heating oil tank vent alarm and clearly communicating the amplified audio signal to an individual that is not in close proximity to the vent alarm.

### BACKGROUND OF THE INVENTION

Vent alarms are commonly used on residential heating oil tanks to minimize the chance of a heating oil dealer overfilling a heating oil tank and, thereby, helping to completely avoid an oil spill. Oils spills can result in significant damage to a homeowner's property and to the environment, both of which can be very expensive to clean up. A vent alarm is a small device, such as a whistle, that is typically found between the insides of the oil tank and the vent pipe. The purpose is to signal the person filling the tank that it is full. When oil is pumped into the tank, air is displaced from inside the tank through the vent pipe. As air passes through the vent and the attached vent alarm, it creates a whistling sound that terminates when the tank is full.

Homeowners typically install vent alarms to prevent a release of oil into their cellar or to the environment due to accidental over-pumping of oil into a full tank. The cost to clean up an accidental release of heating oil can run from one thousand dollars to several hundred thousand dollars, and can take several weeks to several years to clean up, depending upon the magnitude of the spill. For this reason, vent alarm systems are often required by state fire code for new installations.

As any heating oil truck driver can attest to, vent pipes are often located in uncomfortable positions/locations, often making them very difficult to hear. For example, the pipe may be on the ground where an oil delivery person would have to kneel uncomfortably for several minutes, or it may be located high on a wall where the delivery person cannot be at or near ear level with the vent alarm. Furthermore, in locations where there is loud existing background noise it can be virtually impossible to hear a conventional vent alarm. This problem is further exacerbated by vent alarms that simply do not emit a loud enough audio signal to begin with.

In view of the limitations of the effectiveness of conventional vent alarms, there has been a long existing need in the heating oil delivery industry for a means for more effectively transmitting a vent alarm audio signal to an oil delivery person, particularly under circumstances where the delivery person is located a distance away from the vent alarm and/or where the audible signal emitted from the vent alarm is either too low to be easily heard or the emitted signal is difficult to hear due to background noises. While one possible approach could be to design vent alarms that give off a louder signal, such an approach would necessarily require reinstallation of all vent alarms. Furthermore, the effectiveness of this approach would still be severely limited in situations where the difficulty hearing a vent alarm audible alert is hampered by great distances and/or loud background noise.

Accordingly, there remains a need in the art for an innovation that will overcome the deficiencies of past approaches and the problems that remain unsolved.

### SUMMARY OF THE INVENTION

The present invention overcomes the deficiencies of the past approaches and the problems that remain unsolved by providing an innovation directed to an audio signal amplification apparatus (i.e., containing a vent alarm amplifier) and a method of use for amplifying an audio signal emitted from a heating oil tank vent alarm and clearly communicating the amplified audio signal to an individual that is not in close proximity to the vent alarm. The audio signal amplification apparatus and the method of use thus increase the ability of the audio signal, being in the form of a vent alarm whistle sound, to be heard, thereby allowing a person filling an oil tank to be able to easily and confidently perceive the cessation of the vent alarm whistle sound so as to prevent any accidental overfilling and oil spill. The audio signal amplification apparatus is configured as a clamp that can be releasably attached to a vent pipe. During oil filling, the apparatus amplifies any vent alarm whistle sound, and transmits it wirelessly to a receiver carried by a person whom is filling the oil tank. In this way, the person filling the oil tank will not miss the cessation of the vent alarm whistle sound and thus accidental overfilling and oil spill can be prevented.

According, in one aspect of the present invention, an audio signal amplification apparatus includes:
a clamp body assembly mechanically configured for clamping onto a structure associated with a sound generating device, the clamp body assembly including a central shell subassembly and a pair of oppositely-curved arm members extending from respective opposite sides of the central shell subassembly for surrounding and clamping a portion of an exterior surface of the structure so as to support the central shell subassembly against the structure; and
an amplifier control assembly supported by the central shell subassembly of the clamp body assembly adjacent to the structure associated with the sound generating device, the amplifier control assembly including a printed circuit (PC) board having amplifier circuitry electrically configured for amplifying an audio signal representing a sound coming from the sound generating device and wirelessly transmitting the amplified audio signal to a location away from the structure.

In another aspect of the present invention, the central shell subassembly includes a front shell member and a back shell member being assembled together for containing and supporting the PC board.

In another aspect of the present invention, the curved arm members of the clamp body assembly are made of semi-flexible material so as to be expandable and thus able to adjust to structures of different cross-sectional sizes.

In another aspect of the present invention, the PC board further includes an on-off switch for activating the amplifier circuitry of the PC board. The clamp body assembly further includes a front cover attached to the front shell member. The amplifier control assembly further includes a push button positioned by the front cover relative to the on-off switch of the PC board for a user to depress and thereby cause actuation of the on-off switch so as to activate the amplifier circuitry of the PC board.

In another aspect of the present invention, the amplifier control assembly further includes a battery contained by the central shell subassembly between the front and back shell members thereof and electrically connected to the amplifier circuitry of the PC board. Further, the battery is rechargeable and the amplifier control assembly further includes a charger plug for connecting the battery to an external charger for charging the rechargeable battery.

In another aspect of the present invention, the amplifier control assembly further includes a microphone for picking up the audio signal and an antenna for receiving the amplified audio signal from the amplifier circuitry of the PC board and wirelessly transmitting the amplified audio signal over a limited range.

In another aspect of the present invention, a vent alarm audio signal amplification apparatus includes:
a clamp body assembly mechanically configured for clamping onto a vent pipe of an oil tank having a vent alarm housed in the vent pipe, the clamp body assembly including a central shell subassembly and a pair of oppositely-curved arm members extending from respective opposite sides of the central shell subassembly for surrounding and clamping a portion of an exterior surface of the vent pipe so as to facilitate attaching to the vent pipe so as to support the central shell subassembly against the vent pipe, the arm members beng made of semi-flexible material so as to be expandable and thus able to adjust to vent pipes of different cross-sectional sizes;
an amplifier control assembly supported by the central shell subassembly of the clamp body assembly adjacent to the vent alarm housed in the vent pipe, the amplifier control assembly including a printed circuit (PC) board having amplifier circuitry electrically configured for amplifying an audio signal representing a vent alarm sound coming from the vent alarm in the vent pipe, and wirelessly transmitting the amplified audio signal to a headphone worn by a person filling oil to the oil tank; and
a clamp device mounted to the clamp body assembly and being adjustable for clamping the clamp body assembly, and thus also the amplifier control assembly, onto the vent pipe having one of different cross-sectional sizes.

In another aspect of the present invention, one of the arm members has a threaded hole formed theethrough. The clamp device includes a threaded shaft threadably inserted through the threaded hole in the one arm member, a knob affixed on an outer end of the threaded shaft outside of the one arm member, and a head affixed on an inner end of the threaded shaft inside of the one arm member such that the clamp device is adjusted by one of turning the knob in one direction so as to rotate the threaded shaft and place the head into engagement with the vent pipe and turning the knob in the opposite direction so as to counter-rotate the threaded shaft and release the head from engagement with the vent pipe.

In another aspect of the present invention, a method of use of an audio signal amplification apparatus includes the steps of:
obtaining an audio signal amplification apparatus which includes
   a clamp body assembly mechanically configured to attach onto a vent pipe of an oil tank having a vent alarm housed in the vent pipe, portions of the clamp body assembly being made of semi-flexible material so as to be expandable and thus able to adjust to vent pipes of different cross-sectional sizes,
   an amplifier control assembly supported by the clamp body assembly and including a printed circuit (PC) board having amplifier circuitry electrically configured for amplifying an audio vent alarm signal coming from the vent alarm in the vent pipe and wirelessly transmitting the amplified audio vent alarm signal, and
   a clamp device mounted to the clamp body assembly and being adjustable for clamping the clamp body assembly, and thus also the amplifier control assembly, onto the vent pipes of different cross-sectional sizes;
attaching the apparatus to the vent pipe by adjusting the clamp device to clamp onto a vent pipe of a correspondingly one of the different cross-sectional sizes;
picking up and amplifying an audio signal representing the vent alarm sound from the vent alarm in the vent pipe; and
wirelessly transmitting the amplified audio signal to a headphone worn by a person filling oil to an oil tank through an oil pipe.

These and other aspects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 presents a top front isometric view of an exemplary embodiment of an audio signal amplification apparatus in accordance with aspects of the present invention;

FIG. 2 presents a front elevation view of the apparatus originally introduced in FIG. 1;

FIG. 3 presents a top plan view of the apparatus originally introduced in FIG. 1;

FIG. 4 presents a rear elevation view of the apparatus originally introduced in FIG. 1;

FIG. 5 presents a side elevation view of the apparatus as seen from the left side in FIG. 3;

FIG. 6 presents a side elevation view of the apparatus as seen from the right side in FIG. 3;

FIG. 7 presents a bottom plan view of the apparatus originally introduced in FIG. 1;

FIG. 8 presents a bottom front isometric view of the apparatus originally introduced in FIG. 1;

FIG. 9 presents a top front isometric view illustrating the apparatus originally introduced in FIG. 1 before being attached to a vent pipe;

FIG. 10 presents a top front isometric view illustrating the apparatus originally introduced in FIG. 1 after being attached to the vent pipe;

FIG. 11 presents a top front isometric view illustrating the apparatus originally introduced in FIG. 1 after being attached to a vent pipe of a different size;

FIG. 12 presents a diagrammatic view illustrating the apparatus of the present invention transmitting vent alarm sound from the vent pipe to a headphone worn by a person filling the oil tank;

FIG. 13 presents a top front isometric, exploded view of the apparatus originally introduced in FIG. 1; and

FIG. 14 presents a sectional side view of the apparatus taken along line section line 14-14 in FIG. 4.

Like reference numerals refer to like parts throughout the several views of the drawings.

### DETAILED DESCRIPTION OF THE PREFERRED IMPLEMENTATIONS

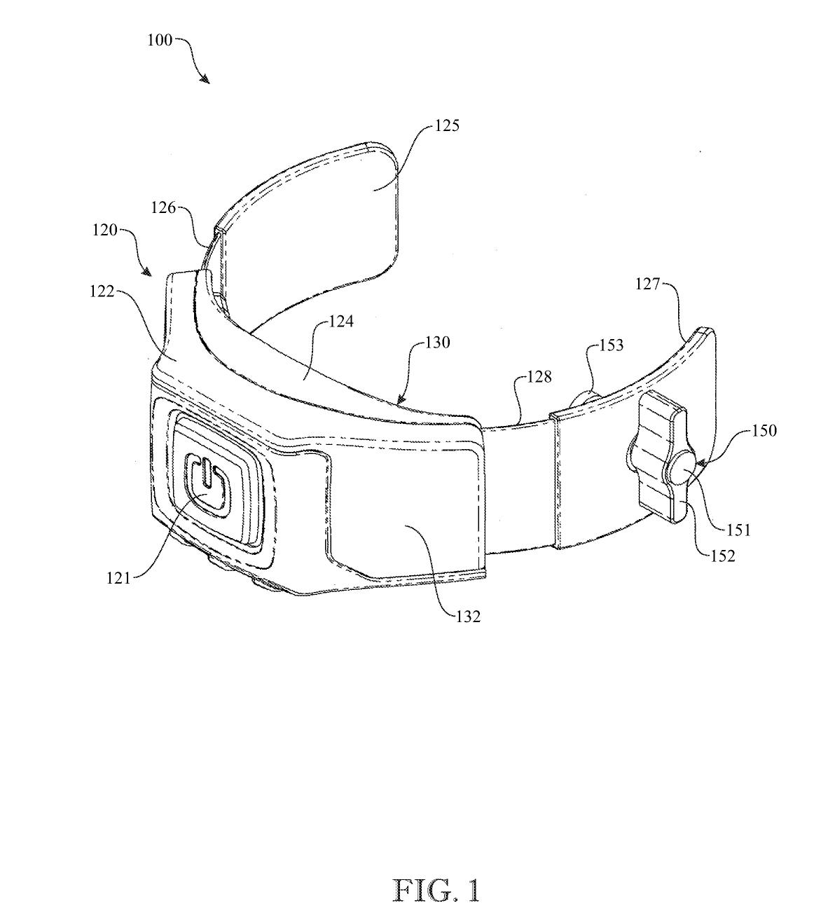

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Shown throughout the figures, the present invention is directed toward a convenient and economical audio signal amplification apparatus that is capable of being easily attached to a vent pipe and increasing the ability of the vent alarm whistle sound being heard by a person filling oil to an oil tank so as to prevent any accidental overfilling and oil spill.

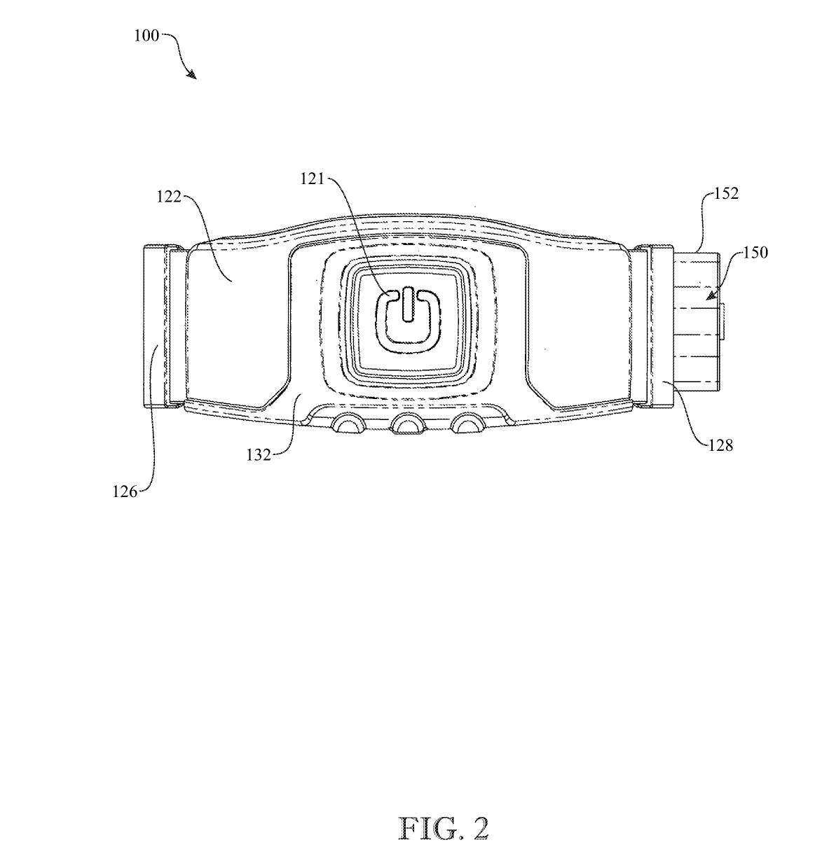

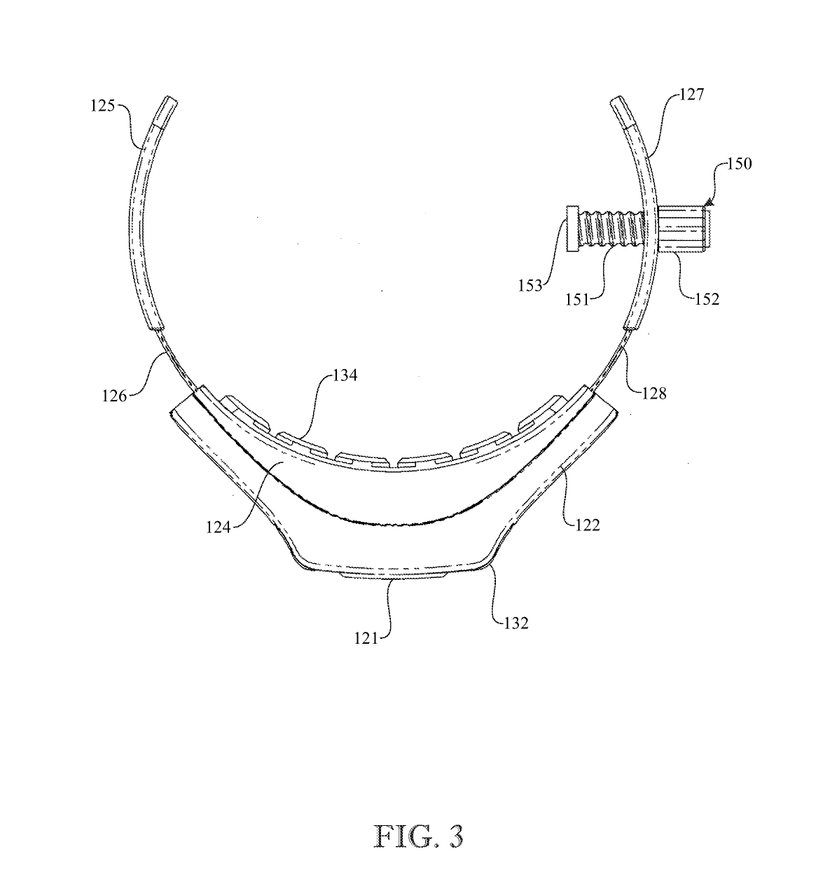

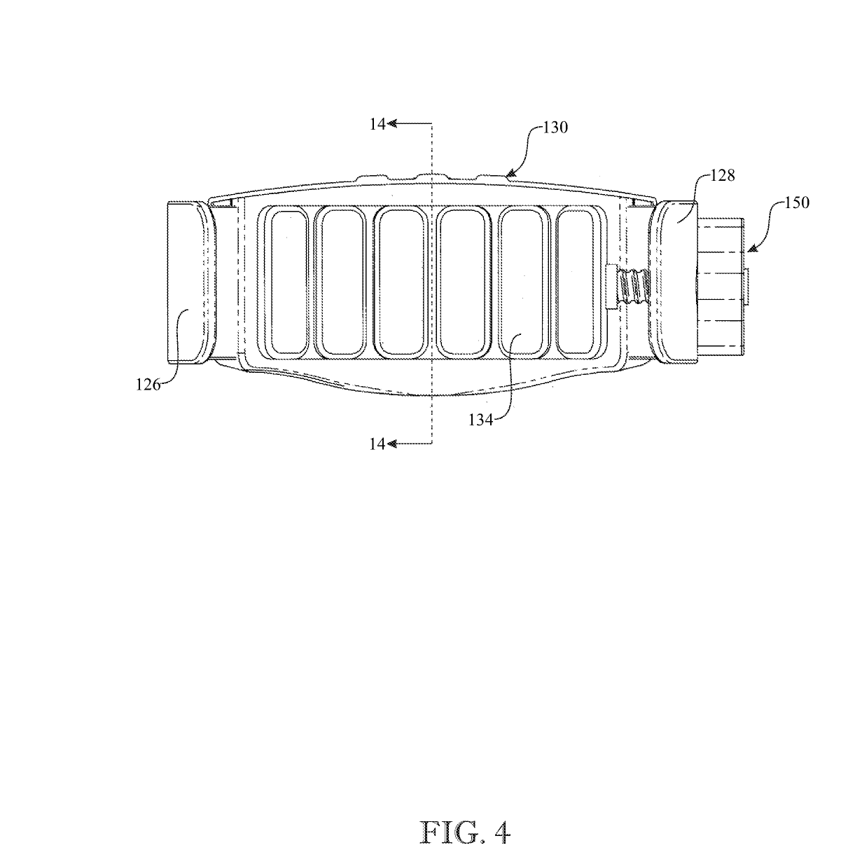

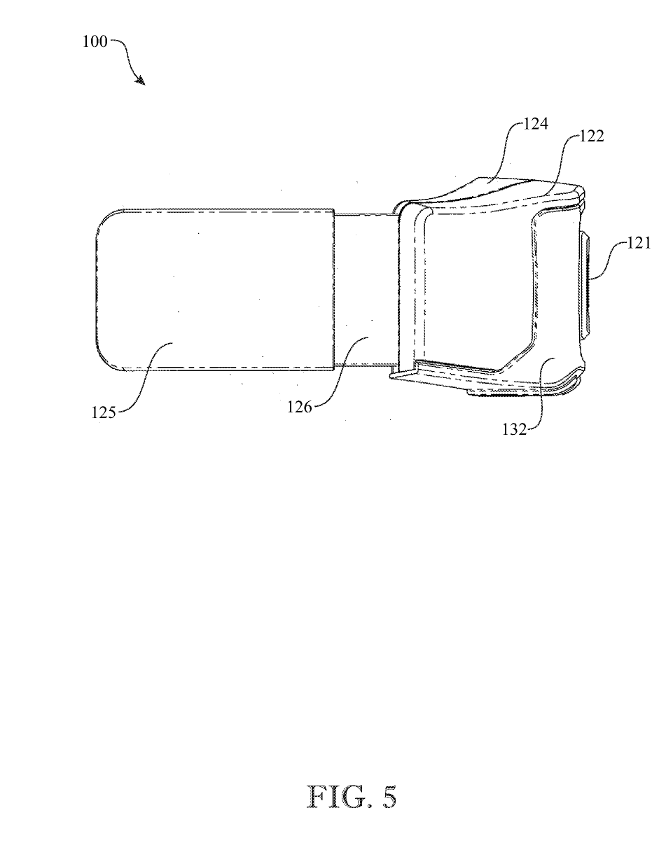

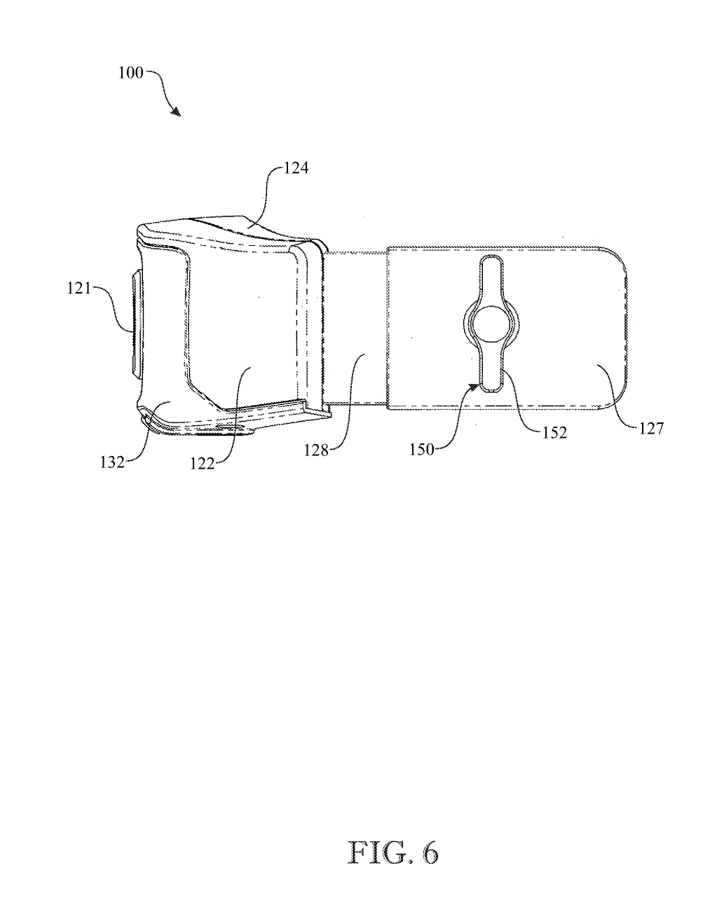

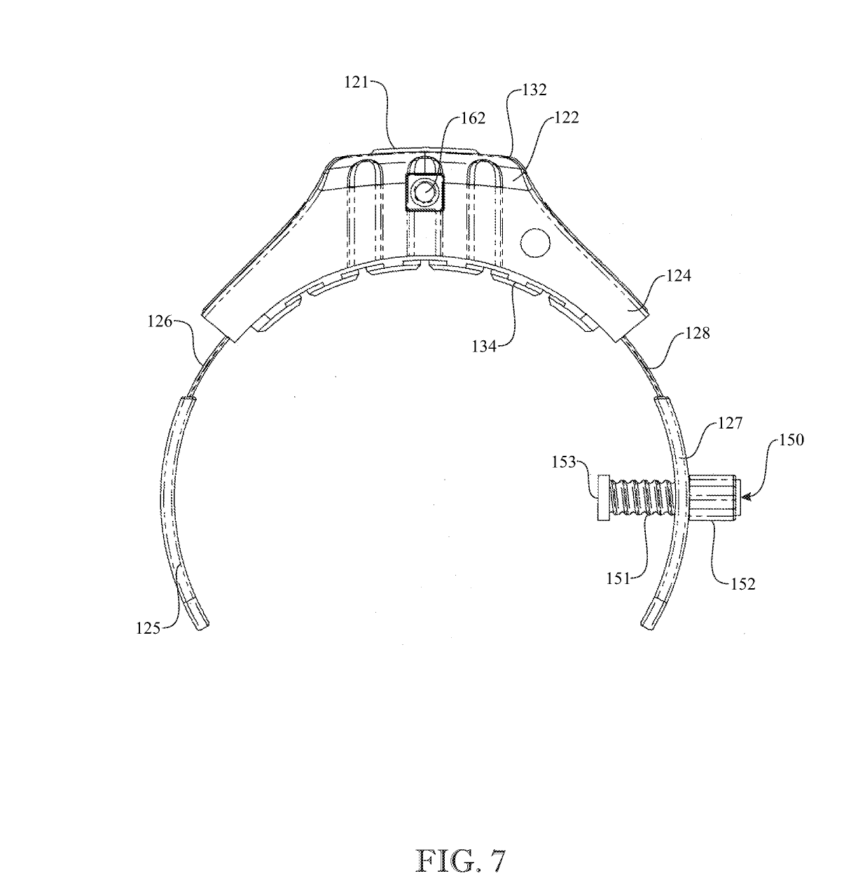

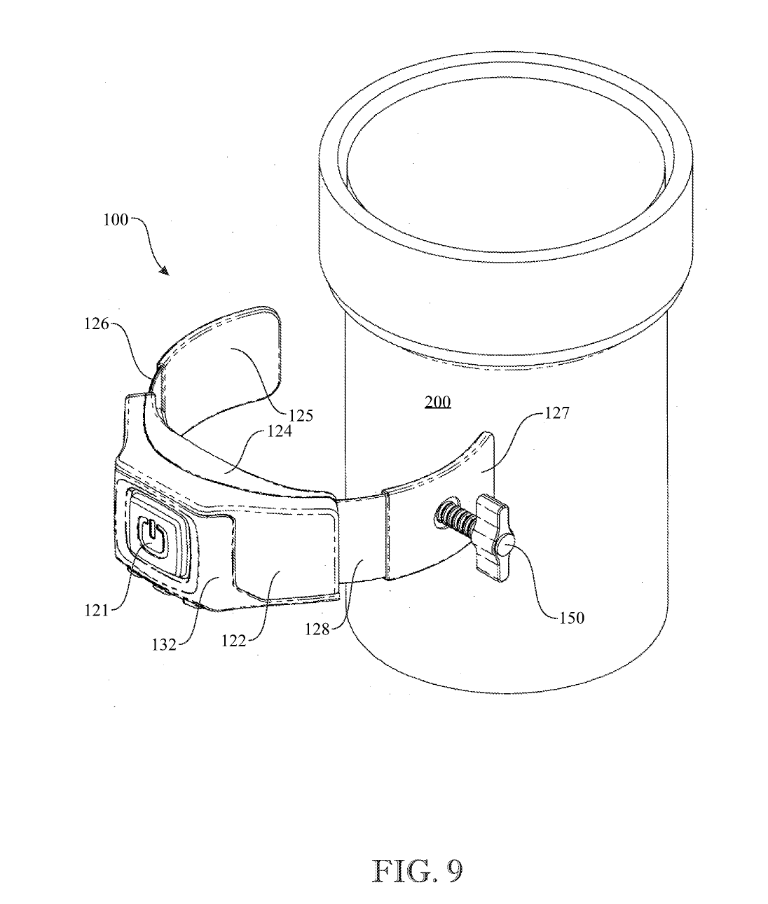

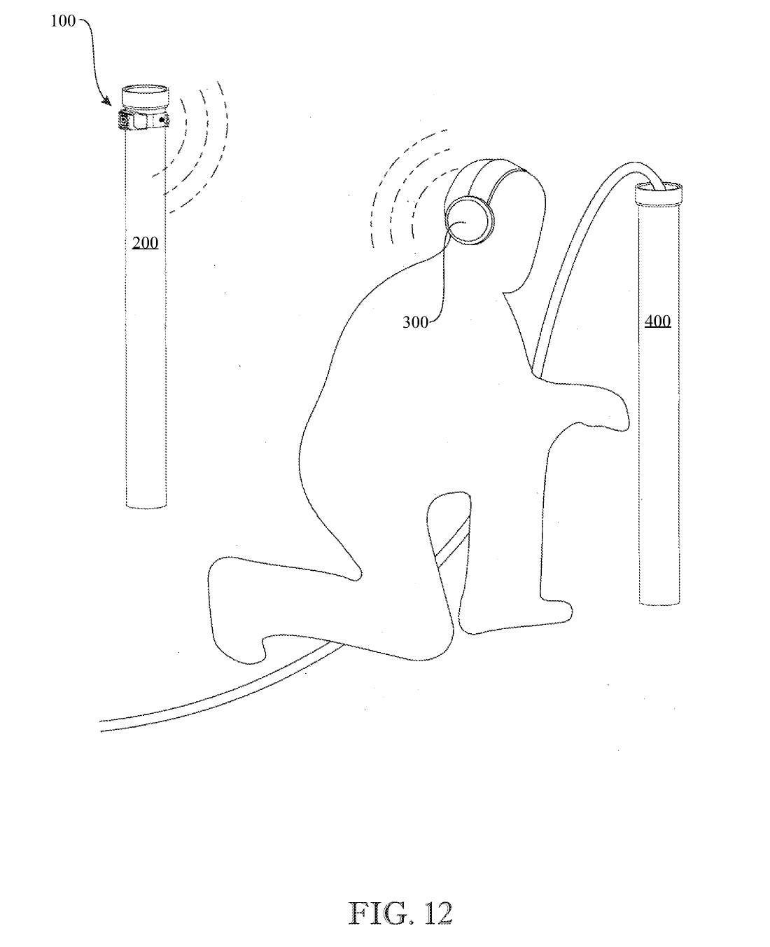

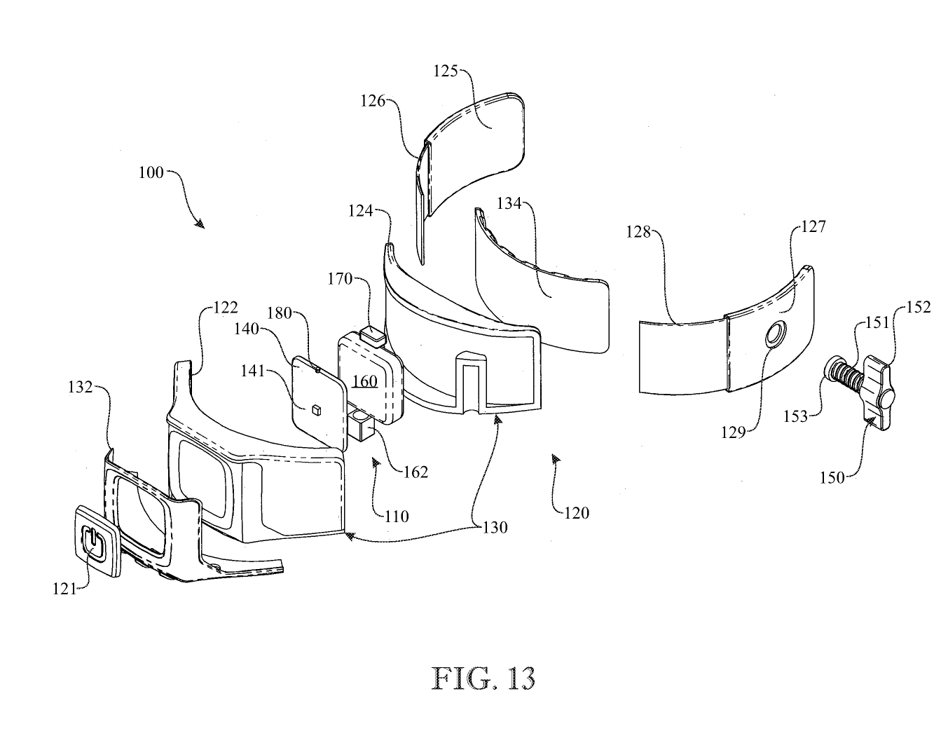

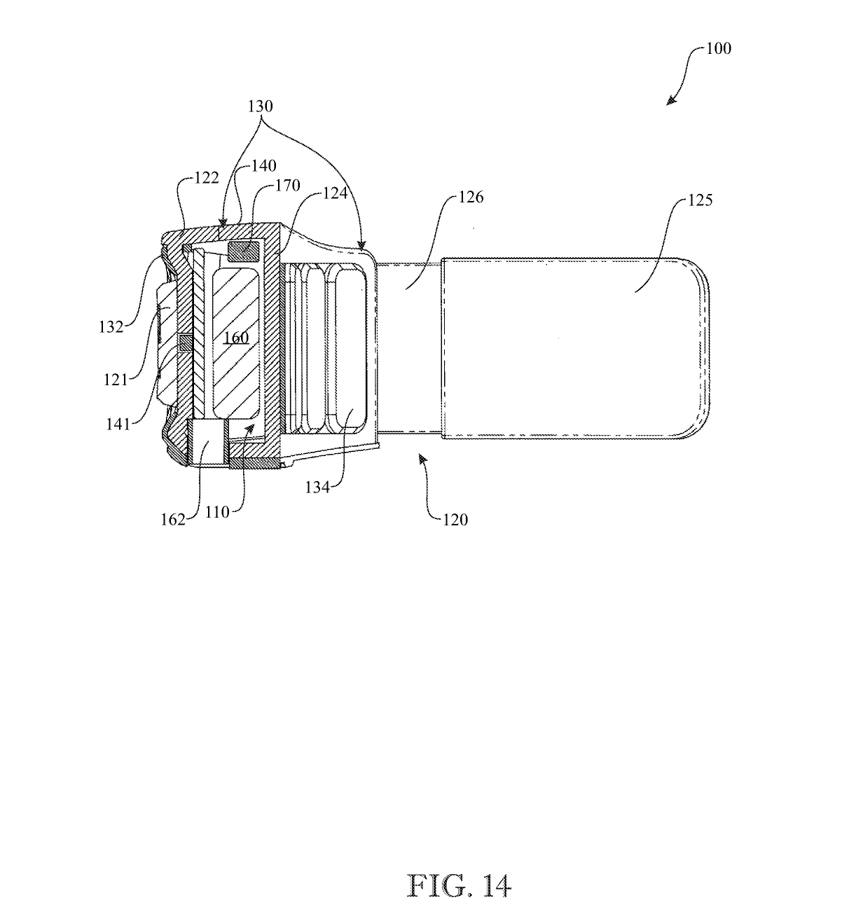

Referring initially to FIGS. 1-8 and 13-14, there is illustrated an exemplary embodiment of an audio signal amplification apparatus, generally designated 100, in accordance with aspects of the present invention. The apparatus 100 basically includes an amplifier control assembly 110 (as seen in FIGS. 13 and 14) and a clamp body assembly 120 housing the amplifier control assembly 110. The clamp body assembly 120 of the apparatus 100 is mechanically configured for clamping onto a structure associated with a sound generating device, such as a vent pipe 200 (see FIGS. 9-12) of an oil tank housing a vent alarm (not shown). The amplifier control assembly 110 of the apparatus 100 is electrically configured for amplifying an audio signal, such as a vent alarm sound coming from the vent alarm in the vent pipe 200, and wirelessly transmitting the amplified audio signal to a receiver (not shown) incorporated by a headphone 300 (see FIG. 12) worn by a person, for instance, filling oil to the oil tank. More particularly, the amplifier control assembly 110 includes a printed circuit (PC) board 140 containing amplifier circuitry electrically configured for amplifying the audio signal.

The clamp body assembly 120 includes a central shell subassembly 130 including a front shell member 122 and a back shell member 124 being assembled together for accommodating (i.e., supporting, enclosing or containing) the PC board 140. The front shell member 122 and the back shell member 124 can be made of a suitable anti-electrical shock material, such as plastic.

The clamp body assembly 120 also includes two curved ring or arm members 126, 128 extending from each side of the central shell subassembly 130 for surrounding and clamping a portion of an exterior surface of the vent pipe 200 (see FIGS. 9-11) so as to facilitate attaching the apparatus 100 to the vent pipe 200 so as to hold the central shell subassembly 130 against the vent pipe 200. The arm members 126, 128 can be made of carbon steel and are expandable so as to be able to adjust to vent pipes of different sizes. The arm members 126, 128 can each include a cover envelope 125, 127 which can be made of a suitable yieldable resilient material, such as rubber or silicone.

The clamp body assembly 120 further includes a front cover 132 attached to the front shell member 122 and accommodating (i.e., positioning) a push button 121 for activating the circuitry of the PC board 140 of the amplifier control assembly 110 and a back cover 134 attached to the back shell member 124. The front cover 132 and the back cover 134 can be made of a suitable anti-electrical shock material, such as rubber. By depressing the push button 121 the circuitry on the PC board 140 is activated via the depressed push button pushing down the on-off switch 141 on the PC board 140. The push button 121 can light up when the audio signal amplification apparatus 100 is turned on.

The apparatus 100 further includes a clamp device 150 for adustably clamping the clamp body assembly 120, and thus also the amplifier control assembly 110, of the apparatus 100 onto the vent pipe 200. More particularly, as one example, the clamp device 150 includes a threaded shaft 151 threadably inserted through a threaded through hole 129 formed in one of the arm members (in the arm member 128 as shown in the exemplary embodiment). The clamp device 150 may be adjusted by turning a knob 152, such as a butterfly nut, affixed on an outer end of the threaded shaft 151, being outside of the arm member 128, in one direction so as to rotate the threaded shaft 151 and place a head 153, being inside of the arm member 128, into engagement with the vent pipe 200, or by turning the knob 152 in the opposite direction so as to counter-rotate the threaded shaft 151 and release the head 153 from engagement with the vent pipe 200.

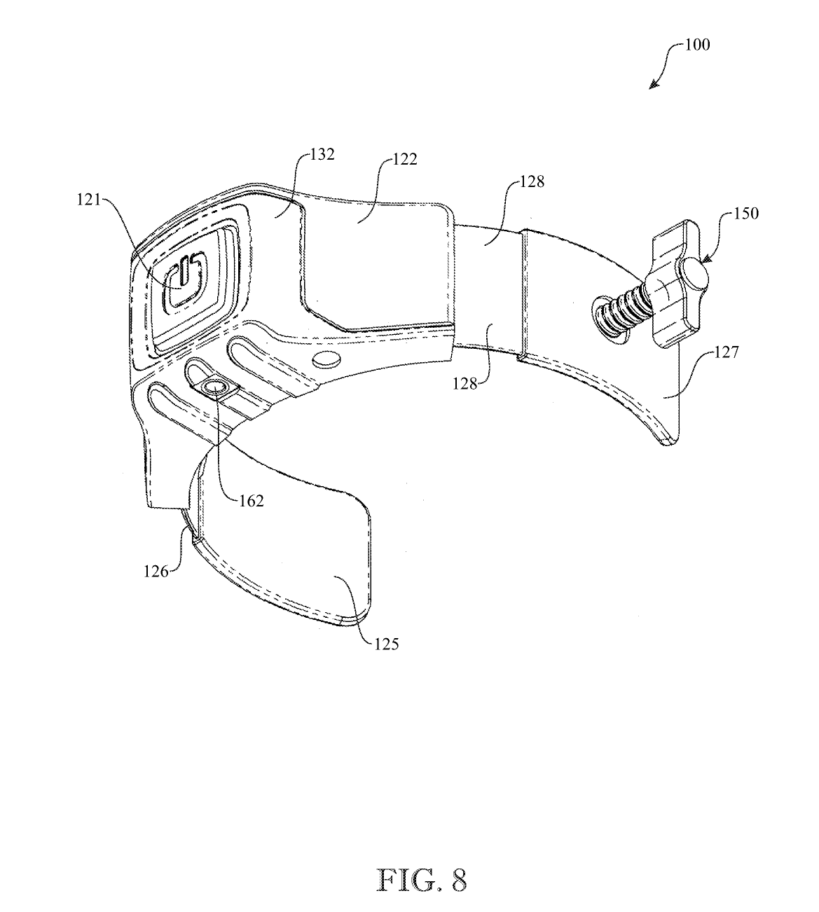

As seen in FIGS. 13 and 14, the amplifier control assembly 110 of the apparatus 100 includes, in addition to the PC board 140. a battery 160, preferably rechargeable, being accommodated (i.e., enclosed or contained) between the front shell member 122 and the back shell member 124 of the central shell subassembly 130 and electrically connected to the amplifier circuitry of the PC board 140. Also, a charger plug 162 (as also seen in FIG. 8) can be provided in the amplifier control assembly 110 for connecting the battery 160 to an external charger for charging the rechargeable battery 160. The amplifier control assembly 110 of the apparatus 100 can additionally include a microphone 170 and an antenna 180 for wirelessly transmitting the amplified audio signal, as one typically transmitted over a short range, for example, a corresponding radio signal or a Bluetooth signal.

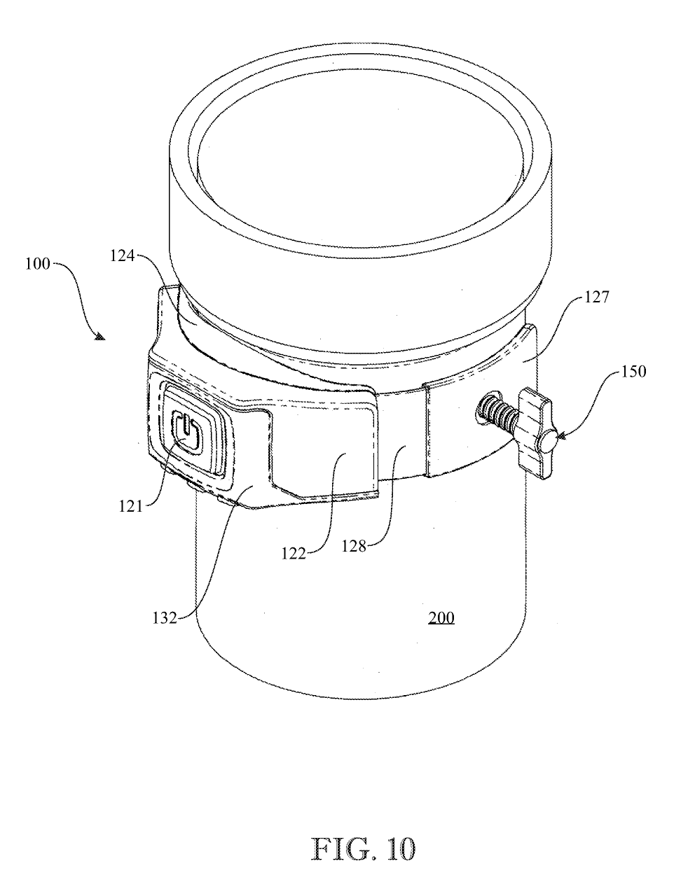

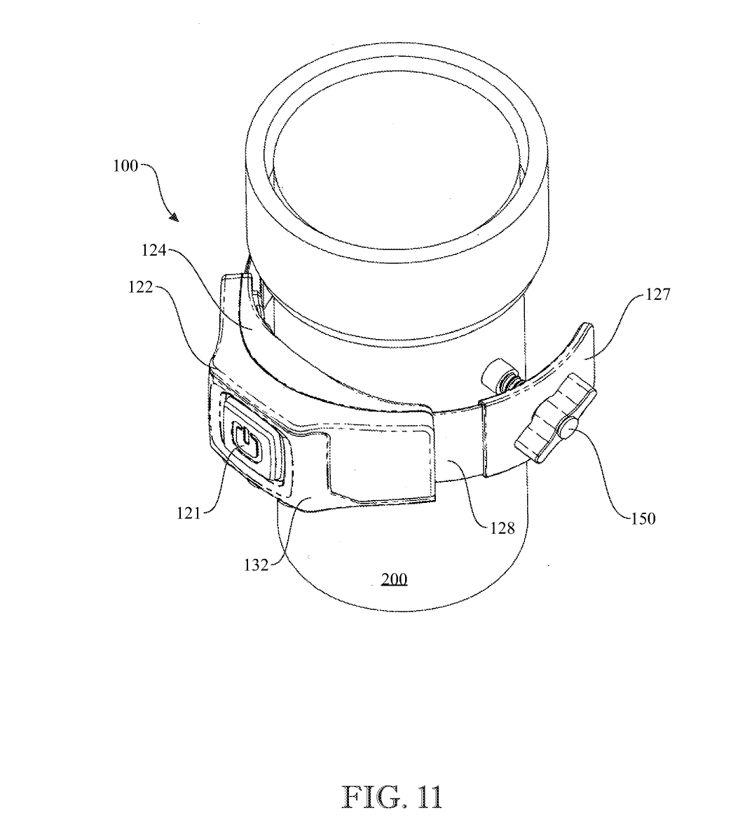

Referring now to FIGS. 9-12, there is illustrated an exemplary embodiment of a method of use of the audio signal amplification apparatus 100, in accordance with aspects of the present invention, for amplifying the audio signal emitted from the heating oil tank vent alarm (not shown) in the vent pipe 200 and clearly communicating the amplified audio signal to the headphone 300 on an individual that is not in close proximity to the vent alarm. FIG. 9 shows the apparatus 100 before being attached to the vent pipe 200. FIG. 10 shows the apparatus 100 after being attached to the vent pipe 200. FIG. 11 shows apparatus 100 after being attached to a vent pipe 200′ having a smaller diameter compared to the vent pipe 200. As shown, the apparatus 100 of the present invention can be adjustably clamped onto vent pipes of different diameters or cross-sectional sizes by correspondingly adjusting the clamp device 150. FIG. 12 diagrammatically shows the apparatus 100 attached to the vent pipe 200 and transmitting vent alarm sound from the vent pipe 200 wirelessly to the headphone 300 worn by a person filling oil to an oil tank through the oil pipe 400.

The above-described embodiments are merely exemplary illustrations of implementations set forth for a clear understanding of the principles of the invention. Many variations, combinations, modifications or equivalents may be substituted for elements thereof without departing from the scope of the invention. Therefore, it is intended that all matters in the foregoing description and shown in the accompanying drawings be interpreted as illustrative and not in a limiting sense. Thus, the scope of the invention should be determined by the appended claims and their legal equivalents.

What is claimed is:

1. An audio signal amplification apparatus, comprising:
a clamp body assembly mechanically configured for clamping onto a structure associated with a sound generating device, said clamp body assembly comprising a central shell subassembly and a pair of oppositely-curved arm members extending from respective opposite sides of said central shell subassembly for surrounding and clamping a portion of an exterior surface of the structure so as to support the central shell subassembly against the structure; and
an amplifier control assembly supported by said central shell subassembly of said clamp body assembly adjacent to the structure associated with the sound generating device, said amplifier control assembly including a printed circuit (PC) board having amplifier circuitry electrically configured for amplifying an audio signal representing a sound coming from the sound generating device and wirelessly transmitting the amplified audio signal to a location away from the structure.

2. The apparatus of claim 1 wherein said central shell subassembly includes a front shell member and a back shell member being assembled together for containing and supporting said PC board.

3. The apparatus of claim 2 wherein said front shell member and back shell member of said central shell subassembly are made of an anti-electrical shock material.

4. The apparatus of claim 1 wherein said arm members of said clamp body assembly are made of semi-flexible material so as to be expandable and thus able to adjust to structures of different cross-sectional sizes.

5. The apparatus of claim 4 wherein each of said arm members of said clamp body assembly has a cover envelope made of a yieldable resilient material.

6. The apparatus of claim 1 further comprising a clamp device mounted on said clamp body assembly for adjustably clamping said clamp body assembly, and thus also said amplifier control assembly, onto the structure.

7. The apparatus of claim 6 wherein:
said clamp body assembly includes a threaded hole formed through one of said arm members of said clamp body assembly; and
said clamp device comprises
a threaded shaft threadably inserted through said threaded hole in said one arm member of said clamp body assembly,
a knob affixed on an outer end of said threaded shaft outside of said one arm member, and
a head affixed on an inner end of said threaded shaft inside of said one arm member such that said clamp device is adjusted by one of turning said knob in one direction so as to rotate said threaded shaft and place said head into engagement with the structure and turning said knob in the opposite direction so as to counter-rotate said threaded shaft and release said head from engagement with the structure.

8. The apparatus of claim 1 wherein:
said PC board further comprises an on-off switch for activating said amplifier circuitry of said PC board;
said clamp body assembly further comprises a front cover attached to said front shell member; and
said amplifier control assembly further comprises a push button positioned by said front cover relative to said on-off switch of said PC board for a user to depress and thereby cause actuation of said on-off switch so as to activate said amplifier circuitry of said PC board.

9. The apparatus of claim 8 wherein said push button is configured to light up when said amplifier circuitry of said PC board is turned on.

10. The apparatus of claim 8 wherein said clamp body assembly further comprises a back cover attached to said front shell member, said front and back covers of said clamp body assembly being made of anti-electrical shock material.

11. The apparatus of claim 2 wherein said amplifier control assembly further comprises a battery contained by said central shell subassembly between the front and back shell members thereof and electrically connected to the amplifier circuitry of said PC board.

12. The apparatus of claim 11 wherein said battery is rechargeable and said amplifier control assembly further comprises a charger plug for connecting said battery to an external charger for charging said rechargeable battery.

13. The apparatus of claim 1 wherein said amplifier control assembly further comprises:
a microphone for picking up the audio signal; and
an antenna for receiving the amplified audio signal from said amplifier circuitry of said PC board and wirelessly transmitting the amplified audio signal over a limited range.

14. An vent alarm audio signal amplification apparatus, comprising:
a clamp body assembly mechanically configured for clamping onto a vent pipe of an oil tank having a vent alarm housed in the vent pipe, said clamp body assembly comprising a central shell subassembly and a pair of oppositely-curved arm members extending from respective opposite sides of said central shell subassembly for surrounding and clamping a portion of an exterior surface of the vent pipe so as to facilitate attaching to the vent pipe so as to support the central shell subassembly against the vent pipe, said arm members of said clamp body assembly being made of semi-flexible material so as to be expandable and thus able to adjust to vent pipes of different cross-sectional sizes;
an amplifier control assembly supported by said central shell subassembly of said body assembly adjacent to the vent alarm housed in the vent pipe, said amplifier control assembly including a printed circuit (PC) board having amplifier circuitry electrically configured for amplifying an audio signal representing a vent alarm sound coming from the vent alarm in the vent pipe, and wirelessly transmitting the amplified audio signal to a headphone worn by a person filling oil to the oil tank; and
a clamp device mounted to said clamp body assembly and being adjustable for clamping said clamp body assembly, and thus also said amplifier control assembly, onto a vent pipe having one of different cross-sectional sizes.

15. The apparatus of claim 14 wherein:
one of said arm members has a threaded hole formed therethrough; and
said clamp device comprises
a threaded shaft threadably inserted through said threaded hole in said one arm member,
a knob affixed on an outer end of said threaded shaft outside of said one arm member, and
a head affixed on an inner end of said threaded shaft inside of said one arm member such that said clamp device is adjusted by one of turning said knob in one direction so as to rotate said threaded shaft and place said head into engagement with the vent pipe and turning said knob in the opposite direction so as to counter-rotate said threaded shaft and release said head from engagement with the vent pipe.

16. The apparatus of claim 14 wherein:
said PC board further comprises an on-off switch for activating said amplifier circuitry of said PC board;
said clamp body assembly further comprises a front cover attached to said front shell member; and
said amplifier control assembly further comprises a push button positioned by said front cover relative to said on-off switch of said PC board for a user to depress and thereby cause an actuation of said on-off switch so as to activate said amplifier circuitry of said PC board.

17. The apparatus of claim 16 wherein said amplifier control assembly further comprises a battery contained by said central shell subassembly and electrically connected to the amplifier circuitry of said PC board.

18. The apparatus of claim 17 wherein said battery is rechargeable and said amplifier control assembly further comprises a charger plug for connecting said battery to an external charger for charging said rechargeable battery.

19. The apparatus of claim 14 wherein said amplifier control assembly further comprises:
a microphone for picking up the audio signal representing the vent alarm sound coming from the vent alarm in the vent pipe; and
an antenna for receiving the amplified audio signal from said amplifier circuitry of said PC board and wirelessly transmitting the amplified audio signal over a limited range.

20. A method of use of an audio signal amplification apparatus, comprising the steps of:
obtaining an audio signal amplification apparatus which includes
a clamp body assembly mechanically configured to attach onto a vent pipe of an oil tank having a vent alarm housed in the vent pipe, portions of the clamp body assembly being made of semi-flexible material so as to be expandable and thus able to adjust to vent pipes of different cross-sectional sizes,
an amplifier control assembly supported by the clamp body assembly and including a printed circuit (PC) board having amplifier circuitry electrically configured for amplifying an audio vent alarm signal coming from the vent alarm in the vent pipe and wirelessly transmitting the amplified audio vent alarm signal, and
a clamp device mounted to the clamp body assembly and being adjustable for clamping the clamp body assembly, and thus also the amplifier control assembly, onto the vent pipes of different cross-sectional sizes;
attaching the apparatus to the vent pipe by adjusting the clamp device to clamp onto a vent pipe of a correspondingly one of the different cross-sectional sizes;
picking up and amplifying an audio signal representing the vent alarm sound from the vent alarm in the vent pipe; and
wirelessly transmitting the amplified audio signal to a headphone worn by a person filling oil to an oil tank through an oil pipe.
